(19) United States
(12) Patent Application Publication
(10) Pub. No.: US 2026/0180847 A1
(43) Pub. Date: Jun. 25, 2026

(54) ENHANCED OFDM TRANSMISSION

(71) Applicant: HUAWEI TECHNOLOGIES CO., LTD., Shenzhen (CN)

(72) Inventors: Sha Hu, Lund (SE); Mohammad Javad Emadi, Lund (SE)

(21) Appl. No.: 19/539,187

(22) Filed: Feb. 13, 2026

Related U.S. Application Data
(63) Continuation of application No. PCT/EP2023/072396, filed on Aug. 14, 2023.

(51) Int. Cl. H04L 27/26; H04L 5/00

(52) U.S. Cl. CPC H04L 27/2662; H04L 5/0048; H04L 5/0053

(57) ABSTRACT

Embodiments of the invention relate to transmission of OFDM symbols from a first communication device (100) to a second communication device (300). Each transmitted OFDM symbol comprises a cyclic prefix part and a data part in the time domain, and the cyclic prefix part comprises at least one sensor signal part. Based on the sensor signal part of the received OFDM symbol, the second communication device (300) may determine a sensing result for the second communication device (300) or a channel measurement of the radio channel. Furthermore, the invention also relates to corresponding methods and a computer program.

### CROSS-REFERENCE TO RELATED APPLICATIONS

This application is a continuation of International Application No. PCT/EP2023/072396, filed on Aug. 14, 2023, the disclosure of which is hereby incorporated by reference in its entirety.

### TECHNICAL FIELD

Embodiments of the invention relate to transmission of OFDM symbols from a first communication device to a second communication device. Furthermore, embodiments of the invention also relate to corresponding methods and a computer program.

### BACKGROUND

Integrated sensing and communication (ISAC), also referred to as joint sensing and communication (JSAC), is an important feature that aims to enhance the 3GPP wireless communication systems such as 5G-new radio (NR) with sensing functionalities, in addition to its communication capabilities. Since orthogonal frequency-division multiplexing (OFDM) is the basic waveform of 5G-NR, OFDM together with its single-carrier (SC) variant discrete Fourier transform (DFT) spread OFDM (DFT-s-OFDM) can be the main transmission waveform also for ISAC.

### SUMMARY

An objective of embodiments of the invention is to provide a solution which mitigates or solves the drawbacks and problems of conventional solutions.

Another objective of embodiments of the invention is to provide a solution for OFDM transmissions with sensing capabilities.

The above and further objectives are solved by the subject matter of the independent claims. Further embodiments of the invention can be found in the dependent claims.

According to a first aspect of the invention, the above mentioned and other objectives are achieved with a first communication device for a communication system, the first communication device being configured to: transmit at least one orthogonal frequency-division multiplexing, OFDM, symbol in a radio channel to a second communication device, the OFDM symbol comprising a cyclic prefix part and a data part in the time domain, and wherein the cyclic prefix part comprises at least one sensor signal part.

The OFDM symbol may also be understood as a DFT-s-OFDM symbol.

The cyclic prefix (CP) part and the data part are used for data transmissions, i.e., for communication purpose/application, while the sensor signal part is used for sensing purpose/application in the communication system.

An advantage of the first communication device according to the first aspect is that the sensor signal part is fully contained in the CP part of the OFDM symbol, and thusly can be made fully compatible to current 5G-NR system and still provide sensing capability.

In an implementation form of a first communication device according to the first aspect, the sensor signal part is arranged in a first part of the cyclic prefix part.

In an implementation form of a first communication device according to the first aspect, a time duration of the sensor signal part is less than the duration of the cyclic prefix part.

An advantage with this implementation form is that if the remaining CP part, i.e., the CP part that excludes the duration of the sensor signal part from the original CP duration, is less than the longest channel delay, the OFDM system can befree from inter-symbol-interference (ISI), and the sensor signal will thus not cause interference to the data part.

In an implementation form of a first communication device according to the first aspect, the sensor signal part is in the first sample of the cyclic prefix part.

An advantage with this implementation form is that it has negligible impact to the existing OFDM symbol. Since all the sensing power in the OFDM symbol is concentrated into the first sample, the peak-to-average-power (PAPR) could be increased for high sensing performance. However, since the PAPR of OFDM symbols is relatively high, especially with large bandwidth and high-order modulations, the sensing power can be set to a value that may not impact the PAPR.

In an implementation form of a first communication device according to the first aspect, the sensor signal part is: overlayed in the cyclic prefix part, or arranged in an empty time slot of the cyclic prefix part.

That the sensor signal part is overlayed may also be understood that the sensor signal part is superimposed with existing OFDM samples in the CP part. That the sensor signal part is arranged in an empty slot may be understood that the sensor signal part replaces existing OFDM samples in the CP part.

In an implementation form of a first communication device according to the first aspect, the first communication device is configured to: transmit a plurality of OFDM symbols to the second communication device, each OFDM symbol comprising a cyclic prefix part comprising a sensor signal part.

An advantage with this implementation form is that the sensing period of the sensor signal part can span multiple OFDM symbols, which can provide higher sensing performance.

In an implementation form of a first communication device according to the first aspect, the sensor signal parts of the plurality of OFDM symbols have the same time distribution in the cyclic prefix parts or different time distribution in the cyclic prefix parts of the plurality of OFDM symbols.

An advantage with this implementation form is that in the case the plurality of OFDM symbols have the same time distribution in the cyclic prefix parts the control signaling designed to indicate the position and duration of the sensor signal part is the same for the plurality of OFDM symbols, and thus reducing the overhead of control signaling. However, if the sensor signal parts of the plurality of OFDM symbols have different time distribution in the CP parts of the plurality of OFDM symbols, it provides more flexibilities in the design of sensor signals, at a cost of higher overhead of controlling signal, compared to the former case with the same time distribution in the cyclic prefix parts.

In an implementation form of a first communication device according to the first aspect, the sensor signal part is any one of: a radar signal, a single pulse wave, and a transformed signal based on a pilot signal in the delay-doppler domain transformed into the time-frequency domain.

In an implementation form of a first communication device according to the first aspect, the first communication device is configured to: reduce or eliminate pilot signal parts in the data part of the OFDM symbol.

In an implementation form of a first communication device according to the first aspect, the first communication device is configured to: transmit a first control signal to the second communication device, the first control signal indicating at least one of: an information about the sensor signal part, a hand-shake request for reception of the sensor signal part, and a request for a channel measurement of the radio channel.

An advantage with this implementation form is that the information about the sensor signal part is transmitted to the second communication device, and the second communication device can therefore differentiate the sensor signal part from the other signal parts of the OFDM symbol.

In an implementation form of a first communication device according to the first aspect, the first communication device is configured to: receive a second control signal from the second communication device, the second control signal indicating a hand-shake response for reception of the sensor signal part and/or the channel measurement of the radio channel.

An advantage with this implementation form is that the second communication device, due to its design constraints or the measurements of radio channel, can send an indication to the first communication device whether to activate transmission of the sensor signal from the first communication device, and also indicate the channel measurements of the radio channel between the first communication device and the second communication device.

In an implementation form of a first communication device according to the first aspect, the channel measurement comprises information about a longest time delay of the radio channel.

An advantage with this implementation form is that the first communication device can design the sensor signal part according to the reported channel measurements.

In an implementation form of a first communication device according to the first aspect, the first control signal is a radio resource control signal or a downlink control signal; and/or the second control signal is a radio resource control signal or an uplink control signal.

An advantage with this implementation form is that the transmission scheme herein disclosed can be well controlled and under full negotiations between the first communication device and the second communication device, to mitigate the impact between sensing and communication functionalities.

According to a second aspect of the invention, the above mentioned and other objectives are achieved with a second communication device for a communication system, the second communication device being configured to: receive at least one OFDM symbol in a radio channel from a first communication device, the OFDM symbol comprising a cyclic prefix part and a data part in the time domain, and wherein the cyclic prefix part comprises at least one sensor signal part.

An advantage of the second communication device according to the second aspect is that the sensor signal part is fully contained in the CP part of the OFDM symbol, and is fully compatible to the current 5G-NR system.

In an implementation form of a second communication device according to the second aspect, the second communication device is configured to: determine a sensing result for the second communication device or a channel measurement of the radio channel based on the sensor signal part of the received OFDM symbol.

An advantage with this implementation form is that based on the sensor signal part of the received OFDM symbol, the second communication device can use the received sensor signal for sensing applications as well. In particular, if the sensor signal is well designed such as are transferred from sparse pilots in the delay Doppler (DD) domain, it can also be used for enhancing the channel estimation in addition to the sensing capabilities.

In an implementation form of a second communication device according to the second aspect, the second communication device is configured to: receive a first control signal from the first communication device, the first control signal indicating at least one of: an information about the sensor signal part, a hand-shake request for reception of the sensor signal part, and a request for a channel measurement of the radio channel.

An advantage with this implementation form is that the control information about the sensor signal is transmitted to the second communication device, and the second communication device can therefore differentiate the sensor signal part from the other signal parts of the OFDM symbol.

In an implementation form of a second communication device according to the second aspect, the second communication device is configured to: transmit a second control signal to the first communication device, the second control signal indicating a hand-shake response for reception of the sensor signal part and/or the channel measurement of the radio channel.

An advantage with this implementation form is that the second communication device, due to the design constraints or based on the measurements of the radio channel, can send an indication to the first communication device whether to accept the activation of transmission of sensor signal from the first communication device. It can also indicate the channel measurements of the radio channel between the first communication device and the second communication device.

In an implementation form of a second communication device according to the second aspect, the channel measurement comprises information about a longest time delay of the radio channel.

An advantage with this implementation form is that the first communication device can design the sensor signal part according to the reported channel measurements, such that the duration of the sensor signal is less than the difference of the CP duration and the longest channel delay.

In an implementation form of a second communication device according to the second aspect, the sensor signal part is arranged in a first part of the cyclic prefix part.

In an implementation form of a second communication device according to the second aspect, a time duration of the sensor signal part is less than the duration of the cyclic prefix part.

An advantage with this implementation form is that if the remaining CP part, i.e., the CP part that excludes the duration of the sensor signal part from the CP duration, is less than the longest channel delay, the OFDM system will bel free from ISI, and the sensor signal will thus not cause interference to the OFDM data part.

In an implementation form of a second communication device according to the second aspect, the sensor signal part is in the first sample of the cyclic prefix part.

An advantage with this implementation form is that it can have negligible impacts to the existing OFDM symbol. Since all the sensing power in the OFDM symbol is concentrated into the first sample, the PAPR can be increased for high sensing performance. However, since the PAPR of OFDM symbols is relatively high, especially with large bandwidth and high-order modulations, the sensing power can be set to a value that may not impact the PAPR.

In an implementation form of a second communication device according to the second aspect, the sensor signal part is: overlayed in the cyclic prefix part, or arranged in an empty time slot of the cyclic prefix part.

In an implementation form of a second communication device according to the second aspect, the second communication device is configured to: receive a plurality of OFDM symbols from the first communication device, each OFDM symbol comprising a cyclic prefix part comprising a sensor signal part.

An advantage with this implementation form is that the sensing period of the sensor signal part can span multiple OFDM symbols, which can yield higher sensing performance.

In an implementation form of a second communication device according to the second aspect, the sensor signal parts of the plurality of OFDM symbols have the same time distribution in the cyclic prefix parts or different time distribution in the cyclic prefix parts of the plurality of OFDM symbols.

An advantage with this implementation form is that in the case the plurality of OFDM symbols have the same time distribution in the cyclic prefix parts the control signaling designed to indicate the position and duration of the sensor signal part is the same for the plurality of OFDM symbols, and thus reducing the overhead of control signaling. However, if the sensor signal parts of the plurality of OFDM symbols have different time distribution in the CP parts of the plurality of OFDM symbols, it provides more flexibilities in the design of sensor signals, at a cost of higher overhead of controlling signal, compared to the former case with the same time distribution in the cyclic prefix parts.

In an implementation form of a second communication device according to the second aspect, the sensor signal part is any one of: a radar signal, a single pulse wave, and a transformed signal based on a pilot signal in the delay-doppler domain transformed into the time-frequency domain.

According to a third aspect of the invention, the above mentioned and other objectives are achieved with a method for a first communication device, the method comprises: transmitting at least one OFDM symbol in a radio channel to a second communication device, the OFDM symbol comprising a cyclic prefix part and a data part in the time domain, and wherein the cyclic prefix part comprises at least one sensor signal part.

The method according to the third aspect can be extended into implementation forms corresponding to the implementation forms of the first communication device according to the first aspect. Hence, an implementation form of the method comprises the feature(s) of the corresponding implementation form of the first communication device.

The advantages of the methods according to the third aspect are the same as those for the corresponding implementation forms of the first communication device according to the first aspect.

According to a fourth aspect of the invention, the above mentioned and other objectives are achieved with a method for a second communication device, the method comprises: receiving at least one OFDM symbol in a radio channel from a first communication device, the OFDM symbol comprising a cyclic prefix part and a data part in the time domain, and wherein the cyclic prefix part comprises at least one sensor signal part.

The method according to the fourth aspect can be extended into implementation forms corresponding to the implementation forms of the second communication device according to the second aspect. Hence, an implementation form of the method comprises the feature(s) of the corresponding implementation form of the second communication device.

The advantages of the methods according to the fourth aspect are the same as those for the corresponding implementation forms of the second communication device according to the second aspect.

Embodiments of the invention also relate to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a first communication device according to an embodiment of the invention;

FIG. 2 shows a flow chart of a method for a first communication device according to an embodiment of the invention;

FIG. 3 shows a second communication device according to an embodiment of the invention;

FIG. 4 shows a flow chart of a method for a second communication device according to an embodiment of the invention;

FIG. 5 shows a communication system according to an embodiment of the invention; and

FIG. 6 shows an OFDM symbol structure according to an embodiment of the invention;

FIG. 7 shows a plurality of OFDM symbols according to an embodiment of the invention;

FIG. 8 shows a plurality of OFDM symbols according to another embodiment of the invention; and

FIG. 9 shows signaling related to transmission of OFDM symbol(s) according to an embodiment of the invention; and

FIG. 10 shows DD pilots sending and channel spreads in the DD domain according to an embodiment of the invention.

### DETAILED DESCRIPTION

Conventional channel estimation is based on measuring known pilots or reference signals. Most OFDM systems including 5G-NR are pilot-based. That is, the channel state information (CSI) is derived and estimated with various pilots e.g., CSI reference signal (CSI-RS), demodulation reference signal (DMRS), sounding reference signal (SRS), etc.

Under double selective channels including multiple-path fading and Doppler-spreads such as e.g., high speed train (HST) channels, the channel estimation quality and data-transmission performance can be degraded. To overcome these issues, orthogonal time frequency space (OTFS), which is known to be more robust than OFDM, is proposed as a new-wave form. However, the data-detection complexity for OTFS is much higher compared to OFDM, which prohibits its practical uses.

In addition to improve the performance under double selective channel, another direction is to enhance the OFDM system with sensing capabilities, which is important for applications including mmWave transmission, vehicle to everything (V2X), massive internet of things (IoT) connections, where positioning and tracking are important for improving the quality of service (QoS) and user-experience. However, the OFDM waveform is not as good as pulse signals or radar signals, when it comes to sensing.

Since the OFDM waveform is not very appealing for sensing, there are proposals to multiplex OFDM with sensing signals by either superposing them together or use different resources for communication (OFDM waveform) and sensing (pulse or radar waveform). While the former proposal provides a higher spectral efficiency, it can degrade both the performance of communication and sensing, due to the interferences to each other. The latter solution yields no cross-interference, but more resources are needed which reduces the spectral efficiency, and also creates more overheads in the switching.

According to embodiments of the invention a solution for enhancing OFDM with sensing capability is therefore provided. The solution is based on a new OFDM symbol structure where a sensor signal part (SSP) is included into a cyclic prefix part (CPP) of an OFDM symbol. The new OFDM symbol structure provides sensing capability to OFDM transmissions and can further provide enhanced channel estimation and reduce pilot signals in OFDM systems for channel estimation.

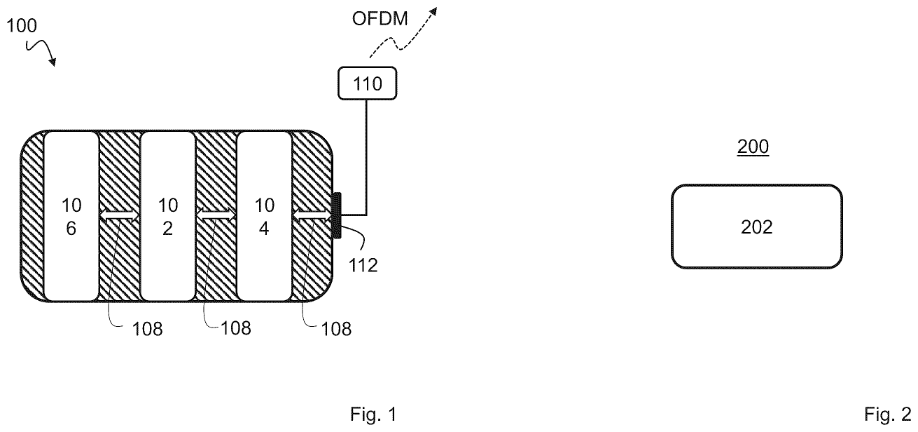

FIG. 1 shows a first communication device 100 according to an embodiment of the invention. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset.

That the first communication device 100 is configured to perform certain actions can in this disclosure be understood to mean that the first communication device 100 comprises suitable means, such as e.g., the processor 102 and the transceiver 104, configured to perform the actions.

According to embodiments of the invention the first communication device 100 is configured to transmit at least one OFDM symbol in a radio channel to a second communication device 300, the OFDM symbol comprising a CPP and a data part in the time domain, and the CPP comprises at least one SSP.

Furthermore, in an embodiment of the invention, the first communication device 100 for a communication system 500 comprises a transceiver configured to: transmit at least one OFDM symbol in a radio channel to a second communication device 300, the OFDM symbol comprising a CPP and a data part in the time domain, and the CPP comprises at least one SSP.

Moreover, in yet another embodiment of the invention, the first communication 100 for a communication system 500 comprises a processor and a memory having computer readable instructions stored thereon which, when executed by the processor, cause the processor to: transmit at least one OFDM symbol in a radio channel to a second communication device 300, the OFDM symbol comprising a CPP and a data part in the time domain, and the CPP comprises at least one SSP.

FIG. 2 shows a flow chart of a corresponding method 200 which may be executed in a first communication device 100, such as the one shown in FIG. 1. The method 200 comprises transmitting 202 at least one OFDM symbol in a radio channel to a second communication device 300, the OFDM symbol comprising a CPP and a data part in the time domain, and the CPP comprises at least one SSP.

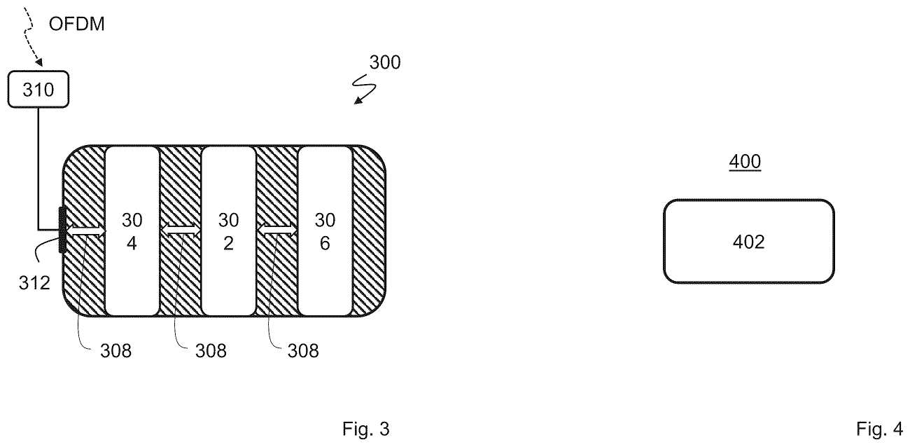

FIG. 3 shows a second communication device 300 according to an embodiment of the invention. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 may be configured for wireless and/or wired communications in a communication system. The wireless communication capability may be provided with an antenna or antenna array 310 coupled to the transceiver 304, while the wired communication capability may be provided with a wired communication interface 312 e.g., coupled to the transceiver 304.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the second communication device 300 is configured to perform certain actions can in this disclosure be understood to mean that the second communication device 300 comprises suitable means, such as e.g., the processor 302 and the transceiver 304, configured to perform the actions.

According to embodiments of the invention the second communication device 300 is configured to receive at least one OFDM symbol in a radio channel from a first communication device 100, the OFDM symbol comprising a CPP and a data part in the time domain, and the CPP comprises at least one SSP.

Furthermore, in an embodiment of the invention, the second communication device 300 for a communication system 500 comprises a transceiver configured to: receive at least one OFDM symbol in a radio channel from a first communication device 100, the OFDM symbol comprising a CPP and a data part in the time domain, and the CPP comprises at least one SSP.

Moreover, in yet another embodiment of the invention, the second communication device 300 for a communication system 500 comprises a processor and a memory having computer readable instructions stored thereon which, when executed by the processor, cause the processor to: receive at least one OFDM symbol in a radio channel from a first communication device 100, the OFDM symbol comprising a CPP and a data part in the time domain, and the CPP comprises at least one SSP.

FIG. 4 shows a flow chart of a corresponding method 400 which may be executed in a second communication device 300, such as the one shown in FIG. 3. The method 400 comprises receiving 402 at least one OFDM symbol in a radio channel from a first communication device 100, the OFDM symbol comprising a CPP and a data part in the time domain, and the CPP comprises at least one SSP.

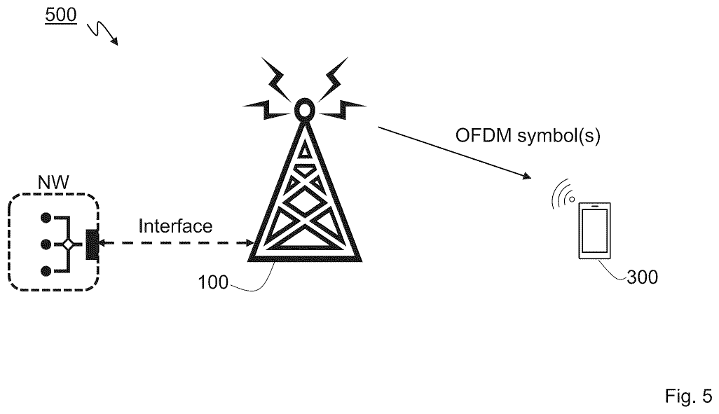

FIG. 5 illustrates a communication system 500 according to an embodiment of the invention. The communication system 500 in the disclosed embodiment comprises a first communication device 100 and a second communication device 300 configured to communicate and operate in the communication system 500. In the shown embodiment, the first communication device 100 is configured as a network access node and the second communication device 300 is configured as a client device. However, in embodiments the first communication device 100 may be configured as a client device and the second communication device 300 may be configured as a client device or a network access node. The first communication device 100 being a network access node may be connected to a network NW such as e.g., a core network over a communication interface. The communication system 500 may be a communication system according to the 3GPP standard such as e.g., a 5G system in which case the client device may be a UE and the network access node may be a next generation node B (gNB) but the invention is not limited thereto.

According to embodiments of the invention, the first communication device 100 transmit a OFDM symbol in a radio channel to the second communication device 300. The OFDM symbol comprises a CPP and a data part in the time domain, and the CPP comprises at least one SSP. The OFDM symbol according to embodiments of the invention is hence enhanced to convey sensing information. The second communication device 300 receives the OFDM symbol in the radio channel from the first communication device 100 and may determine a sensing result for the second communication device 300 or a channel measurement of the radio channel based on the SSP of the received OFDM symbol.

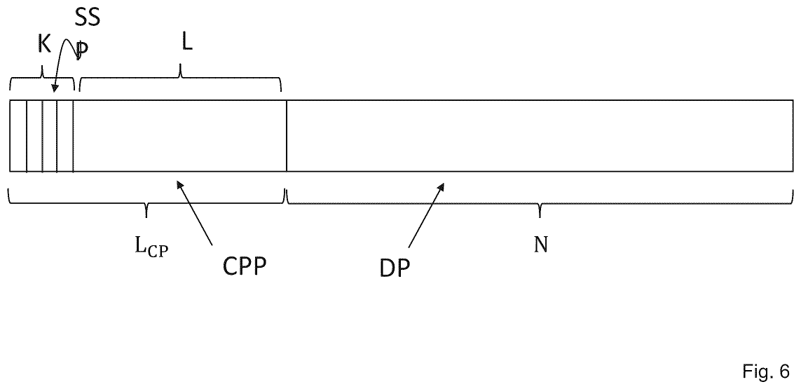

FIG. 6 shows the OFDM symbol structure according to an embodiment of the invention. The OFDM symbol according to the invention may be based on a conventional OFDM symbol structure, such as e.g., the OFDM symbol structure of 5G-NR. With reference to FIG. 6, the OFDM symbol comprises a CPP with a length L_{CP} and a data part (DP) in the time domain with a length N where N is the size of fast-Fourier transform (FFT). The CPP comprises at least one SSP. The length of the SSP is denoted K and may be given in time length or in samples.

With reference to FIG. 6, the SSP may in embodiments of the invention be arranged in a first part of the CPP. The SSP may e.g., be inserted into the first sample or the first few samples of the CPP. In embodiments, the SSP may be in the first sample of the CPP. The SSP may further be in one or more additional samples of the CPP.

In embodiments of the invention, a time duration of the SSP is less than the duration of the CPP. The time duration of the SSP, i.e., the length K, may be 1 sample or more. However, by keeping the length K=1 of the SSP to a suitable value, the impact to the existing OFDM system can be minimized.

Further, there is no interference from the inserted SSP, as long as the channel delay L, the CP length L_{CP}, and the duration K of the SSP, satisfies equation (1):

$$L \leq {L}_{CP} - K . \qquad ( 1 )$$

This is because at the receiver side, only the data part is transferred into the frequency domain for data detection and the whole CPP is discarded as it can be polluted by the interference from a previous OFDM symbol due to the channel delay. However, as long as the condition in equation (1) is met, the data part can be interference free from the SSP. That is, the performance of communication data is not affected by the SSP. Especially when setting the length K of the SSP to a small value such as 1, then it only happens when L≥L_{CP} that the data part will be affected by the SSP.

According to embodiments of the invention, the SSP is overlayed in the CPP, i.e., the sensor signal may be arranged on top of the CP samples. The SSP may e.g., be superimposed in samples in the CPP.

According to embodiments of the invention, the SSP may be arranged in an empty time slot of the CPP. The empty time slot may be obtained by muting one or more CP samples, e.g., not transmitting or removing one or more CP samples.

With reference to FIG. 5, the first communication device 100 transmits at least one OFDM symbol in the radio channel to the second communication device 300. Each transmitted OFDM symbol comprises at least one SSP in the CPP, as described with reference to FIG. 6. The first communication device 100 may transmit one OFDM symbol or transmit a plurality of OFDM symbols to the second communication device 300. Each OFDM symbol comprising a CPP that may comprise a SSP.

The SSP may be any one of: a radar signal, a single pulse wave, and a transformed signal based on a pilot signal in the DD domain transformed into the time-frequency domain. The type of sensor signal used may depend on the use case and application. For example, if the OFDM symbols are intended for sensing and tracking objects, the sensing signal may be any classical pulse wave, e.g., a short pulse wave or a radar waveform. If the OFDM symbols are used for time of arrival (ToA) and channel estimation, the sensing signal may be a transformed signal designed based on transforms, e.g., discrete Fourier transform (DFT) or inverse DFT (IDFT), between the DD domain and the time-frequency domain.

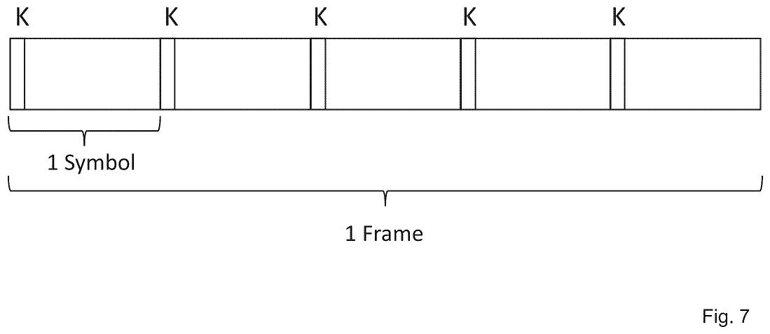

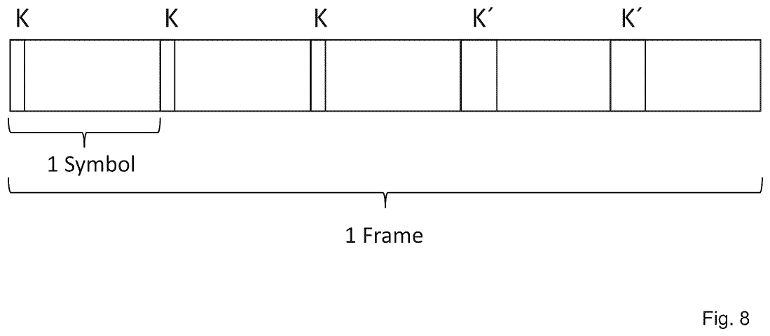

When a plurality of OFDM symbols is transmitted by the first communication device 100, the SSPs of the plurality of OFDM symbols may have the same time distribution in the CPPs or different time distribution in the CPPs of the plurality of OFDM symbols, as shown in FIGS. 7 and 8, respectively.

FIG. 7 shows a plurality of OFDM symbols according to an embodiment of the invention where the SSPs of the plurality of OFDM symbols have the same time distribution in the CPPs. The plurality of OFDM symbols may be referred to as a frame and may be used for ISAC and in this case be denoted an ISAC frame. The ISAC frame may comprise M number of OFDM symbols, where M=5 in the shown example. Each OFDM symbol may have the structure shown in FIG. 6 and the SSP in each OFDM symbol may have the same time distribution. With reference to FIG. 7, the length K of the SSP is hence the same for each OFDM symbol in the ISAC frame. The length of the ISAC frame may be one sensing period for a channel estimation.

FIG. 8 shows a plurality of OFDM symbols according to an embodiment of the invention where the SSPs of the plurality of OFDM symbols have different time distribution in the CPPs. Due to channel variations, the channel delay L may vary within the ISAC frame, and it may also be beneficial to be able to vary the length K of the SSPs for different OFDM symbols to adapt to the channel variations. A flexible frame structure may therefore be provided, where the length K, K′ of the SSP may be different for different OFDM symbol in the frame, as shown in FIG. 8.

In embodiments of the invention, the first communication device 100 may reduce or eliminate pilot signal parts in the data part of the OFDM symbol in the frequency domain. Thus, the at least one OFDM symbol transmitted by the first communication device 100 may comprise a reduced number of pilots or be completely pilot-free to increase spectral efficiency.

Again, with reference to FIG. 5, the second communication device 300 receives the at least one OFDM symbol in the radio channel from the first communication device 100, i.e., second communication device 300 receives one OFDM symbol or a plurality of OFDM symbols from the first communication device 100. Each OFDM symbol comprising a CPP comprising a SSP. Based on the SSP(s) of the received OFDM symbol(s), the second communication device 300 determines a sensing result for the second communication device 300 or a channel measurement of the radio channel. The sensing result may be related to object sensing and tracking, or ToA estimation and object positioning. The channel measurement of the radio channel may be used to determine a channel estimation of the radio channel.

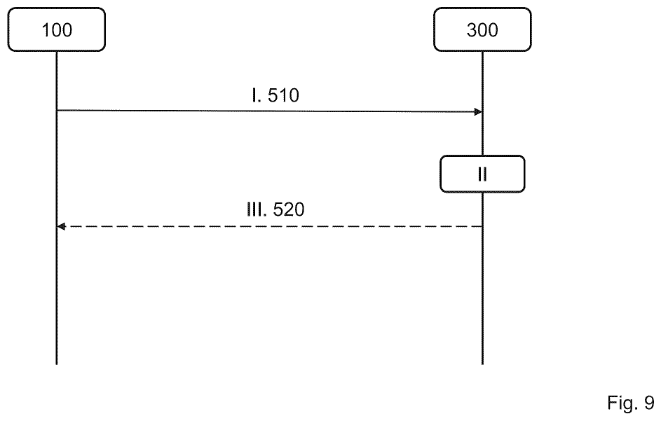

FIG. 9 shows signaling related to transmission of OFDM symbol(s) from the first communication device 100 to the second communication device 300 according to an embodiment of the invention. The signaling may be performed before the transmission of OFDM symbol(s) to e.g., enable the second communication device 300 to properly receive and decode the OFDM symbol(s) and/or trigger a channel measurement of the radio channel based on the OFDM symbol(s).

In step I in FIG. 9, the first communication device 100 transmits a first control signal 510 to the second communication device 300. The first control signal 510 indicates at least one of: an information about the SSP, a hand-shake request for reception of the SSP, and a request for a channel measurement of the radio channel. The information about the SSP may e.g., be related to location and duration of the SSP in the OFDM symbol. The channel measurement may comprise information about a longest time delay of the radio channel.

The second communication device 300 receives the first control signal 510 from the first communication device 100 and hence obtains at least one of: the information about the SSP, the hand-shake request for reception of the SSP, and the request for a channel measurement of the radio channel indicated in the first control signal 510.

In step II in FIG. 9, the second communication device 300 may perform one or more actions based on the received first control signal 510. The second communication device 300 may use the information about the SSP, e.g., location and duration of the SSP, to obtain the SSP from a OFDM symbol received from the first communication device 100. The second communication device 300 may further determine a hand-shake response for reception of the SSP and/or determine the channel measurement of the radio channel.

In step III in FIG. 9, the second communication device 300 may transmit a second control signal 520 to the first communication device 100, the second control signal 520 indicating a hand-shake response for reception of the SSP and/or the channel measurement of the radio channel. The channel measurement may comprise information about the channel delay of the radio channel and especially information about the longest time delay of the radio channel.

The first communication device 100 receives the second control signal 520 from the second communication device 300 and hence obtains the hand-shake response for reception of the SSP and/or the channel measurement of the radio channel indicated in the second control signal 520.

In embodiments, the first control signal 510 is a radio resource control (RRC) signal or a downlink control signal; and/or the second control signal 520 is a RRC signal or an uplink control signal.

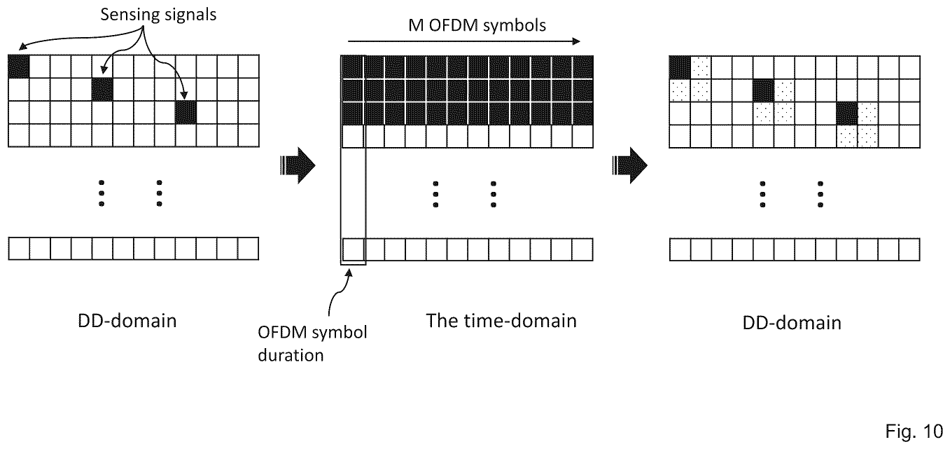

FIG. 10 shows exemplary DD pilots sending and channel spreads in the DD domain according to an embodiment of the invention. Assuming an ISAC frame where the Q sensing samples are denoted s_{q}, it can be generated from K signals dₖ in the DD domain, as shown in FIG. 10.

Firstly, the K signals are assigned with one resource-element (RE) in the DD domain, and such a resource allocation can also depend on the measured channel properties including the maxima delay and the maximal Doppler shift. The DD domain RE grid is illustrated in FIG. 10, with M columns and N rows. In general, assuming the k-th signal is assigned to the (nₖ, mₖ)-th RE, i.e., on the nₖ-th row and m-th column. Then, each signal is transferred into the time domain via the DFT as:

$${t}_{k , m} = \frac{{d}_{k}}{\sqrt{M}} {\sum }_{n = 0}^{M - 1} {e}^{\frac{j 2 π kn}{M}} δ ( k - {m}_{k} ) = \frac{{d}_{k}}{\sqrt{M}} {e}^{\frac{j 2 π {km}_{k}}{M}} . \qquad ( 2 )$$

where δ(k) is the Dirac delta function with δ(0)=1 and δ(k)=0 for k≠0. The same operation is applied to each of the K signals in the DD domain.

Afterwards, the K samples t_{k,m} with the same index m are transmitted as the K samples inserted into the m-th OFDM symbol, following the illustration in the middle figure of FIG. 10.

At the receiver side, to recover the sensing signal in the DD domain, the m samples inserted and received at the same position \tilde{t}_{k,m} on the M ISAC-symbols in an ISAC-frame are applied with an IDFT operation according to:

$$a . {\tilde{d}}_{k , m} = \frac{1}{\sqrt{M}} {\sum }_{n = 0}^{M - 1} {\tilde{t}}_{k , m} {e}^{\frac{- j 2 π kn}{M}} . \qquad ( 3 )$$

Noting that at the transmit side, it holds that:

$$i . {d}_{k , m} = {d}_{k} δ ( k - {m}_{k} ) . \qquad ( 4 )$$

However, the samples \tilde{t}_{k,m} can be polluted by interference from OFDM data part and other sensing signals due to the channel delay and Doppler spread, and hence the recovered sensing signal in the DD domain \tilde{d}_{k,m} is also spread to a larger area.

Since the channel in the DD domain is semi-static, the delay pattern would be identical for all K sensing signals. As dₖ are known before hand, the channel estimation can be estimated in the DD domain.

The channel estimation algorithm may be designed, and a heuristic estimate can be based on the lease square (LS) estimate:

$$i . {\tilde{h}}_{k , m} = {\tilde{d}}_{k , m} / {\tilde{d}}_{k} . \qquad ( 5 )$$

Since the OFDM data and noise are also transferred into the DD domain, a thresholding can be followed to relieve the impacts from noise as:

$$a . {\tilde{h}}_{k , m} = \{ \begin{matrix}{\tilde{h}}_{k , m} & if \vert {\tilde{h}}_{k , m} \vert > threshold , \\ 0 & otherwise .\end{matrix} \qquad ( 6 )$$

Such a threshold can be designed and optimized based on measurement of the OFDM data transmit-power and the noise power.

To evaluate the impact of sensing capability on the communication capability and vice visa, two parameters may be defined i.e., communication to sensing and noise ratio (CSNR) and sensing to communication and noise ratio (SCNR), respectively.

Assuming in the time-domain that the averaged transmit-power of communication signals (i.e., OFDM sample) is P, and the transmit-power of sensing signal is α. That means that setting α=α₀P will not impact the cumulative distribution function (CDF) of PAPR with the proposed new ISAC symbol structure compared to the conventional OFDM symbol. Note that with OFDM system, the peak-to-average-power ratio (PAPR) increases as the fast Fourier transform (FFT) size and modulation order increases, and in general it is larger than a value α₀ with a probability close to 1.

Assuming a delay channel with channel power ∥h∥², i.e., the summation of powers for all channel delay paths, then after transferring to the time-frequency domain, the CSNR equals:

$$CSNR = P / ( \frac{K α}{N} + \frac{{N}_{o}}{{‖ h ‖}^{2}} ) . \qquad ( 7 )$$

However, this is under the assumption that the sensing symbols are transferred into the frequency domain where OFDM implements the channel estimation and data-detection. However, when the condition in equation (1) is met, the sensing symbols are removed before FFT operation, and hence, there is no interference from sensing signal, and it yields CSNR is identical to the SNR of OFDM data transmission,

$$CSNR = SNR = \frac{{‖ h ‖}^{2} P}{{N}_{o}} . \qquad ( 8 )$$

Similarly, after transferring to the DD-domain, the SCNR at the DD-pilot position equals:

$$SCR = MK {α}_{0} / ( 1 + \frac{{N}_{o}}{P {‖ h ‖}^{2}} ) . \qquad ( 9 )$$

As an example, assuming a high SNR case with

$$\frac{{N}_{o}}{P {‖ h ‖}^{2}} = 0 ,$$

and α₀=7 dB, K=1, and M=28 (the number of OFDM symbols in one OFDM subframe), then SCR=21.5 dB. This means that the channel estimation quality according to equations (5)-(6) can be satisfying.

Since the sensing signal has almost no impact on the OFDM system with the proposed ISAC symbol and frame structure, the channel estimation obtained with sensing signal provides other degrees of freedom for the OFDM design. Thus, there are at least two advantages: Using the sensing-signal based channel estimate to improve the OFDM channel estimation, without changing the current pilot design of OFDM.

Reducing the number of pilots in OFDM to increase the spectral efficiency. Such a proposal may require new signalling to notify the second communication device 300 about the new pilot patterns.

As a special case for proposal 2 above, a pilot-free OFDM transmission may be proposed, i.e., that the OFDM data part carries zero pilots and the channel estimation and measurement and reports etc, can be based solely on the SSP.

A first communication device herein may also be denoted as a network access node or a client device and a second communication device herein may be denoted as a network access node or a client device.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first communication device and the second communication device comprise the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device and the second communication device may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A first communication device (100), comprising:
one or more processors configured to:
transmit at least one orthogonal frequency-division multiplexing, OFDM, symbol in a radio channel to a second communication device (300), the OFDM symbol comprising a cyclic prefix part and a data part in the time domain, and wherein the cyclic prefix part comprises at least one sensor signal part.

2. The first communication device (100) according to claim 1, wherein the sensor signal part is arranged in a first part of the cyclic prefix part.

3. The first communication device (100) according to claim 1, wherein the sensor signal part is:
overlayed in the cyclic prefix part, or
arranged in an empty time slot of the cyclic prefix part.

4. The first communication device (100) according to claim 1, configured to:
transmit a plurality of OFDM symbols to the second communication device (300), each OFDM symbol comprising a cyclic prefix part comprising a sensor signal part.

5. The first communication device (100) according to claim 4, wherein the sensor signal parts of the plurality of OFDM symbols have the same time distribution in the cyclic prefix parts or different time distribution in the cyclic prefix parts of the plurality of OFDM symbols.

6. The first communication device (100) according to claim 1, wherein the sensor signal part is any one of: a radar signal, a single pulse wave, and a transformed signal based on a pilot signal in the delay-doppler domain transformed into the time-frequency domain.

7. The first communication device (100) according to claim 1, wherein the one or more processors is further configured to:
transmit a first control signal (510) to the second communication device (300), the first control signal (510) indicating at least one of: an information about the sensor signal part, a hand-shake request for reception of the sensor signal part, and a request for a channel measurement of the radio channel.

8. The first communication device (100) according to claim 7, wherein the one or more processors is further configured to:
receive a second control signal (520) from the second communication device (300), the second control signal (520) indicating a hand-shake response for reception of the sensor signal part and/or the channel measurement of the radio channel.

9. The first communication device (100) according to claim 7, wherein the channel measurement comprises information about a longest time delay of the radio channel.

10. The first communication device (100) according to claim 7, wherein
the first control signal (510) is a radio resource control signal or a downlink control signal; and/or
the second control signal (520) is a radio resource control signal or an uplink control signal.

11. A second communication device (300), comprising:
one or more processors configured to:
receive at least one OFDM symbol in a radio channel from a first communication device (100), the OFDM symbol comprising a cyclic prefix part and a data part in the time domain, and wherein the cyclic prefix part comprises at least one sensor signal part.

12. The second communication device (300) according to claim 11, wherein the one or more processors is further configured to:
receive a first control signal (510) from the first communication device (100), the first control signal (510) indicating at least one of: an information about the sensor signal part, a hand-shake request for reception of the sensor signal part, and a request for a channel measurement of the radio channel.

13. The second communication device (300) according to claim 12, wherein the one or more processors is further configured to:
transmit a second control signal (520) to the first communication device (100), the second control signal (520) indicating a hand-shake response for reception of the sensor signal part and/or the channel measurement of the radio channel.

14. The second communication device (300) according to claim 11, wherein the sensor signal part is:
overlayed in the cyclic prefix part, or
arranged in an empty time slot of the cyclic prefix part.

15. The second communication device (300) according to claim 11, wherein the one or more processors is further configured to:
receive a plurality of OFDM symbols from the first communication device (100), each OFDM symbol comprising a cyclic prefix part comprising a sensor signal part.

16. A method (200) for a first communication device (100), the method (200) comprising:
transmitting (202) at least one OFDM symbol in a radio channel to a second communication device (300), the OFDM symbol comprising a cyclic prefix part and a data part in the time domain, and wherein the cyclic prefix part comprises at least one sensor signal part.
